(19) United States
(12) Patent Application Publication
(10) Pub. No.: US 2016/0171412 A1
(43) Pub. Date: Jun. 16, 2016

(54) Dynamic Scheduling of Water Filler

(71) Applicant: TECHNOLOGICAL RESOURCES PTY LTD., Brisbane, Queensland (AU)

(72) Inventors: Charles Benjamin MCHUGH, Brisbane (AU); Eric William NETTLETON, Brisbane (AU); Benjamin ROGERS, Brisbane (AU)

(21) Appl. No.: 14/902,647

(22) PCT Filed: Jul. 2, 2014
(86) PCT No.: PCT/AU2014/050106

§ 371 Date: Jan. 4, 2016

(30) Foreign Application Priority Data
Jul. 3, 2013 (AU) 2013902465

(51) Int. Cl. G06Q 10/06; G06Q 50/02

(52) U.S. Cl. CPC G06Q 10/06315; G06Q 50/02

(57) ABSTRACT

This disclosure relates to scheduling by a processor the supply a consumable liquid to a mobile machine, such as the supply of water to a blasthole drill. The processor receives from the one or more mobile machines status information relative to a machine cycle. The machine cycle comprises one or more first periods where supply of the consumable liquid is preferred. The processor then determines based on the status information the supply schedule to supply the liquid to the one or more machines during their respective one or more first periods. The supply schedule is determined such that the supply schedule reduces the likelihood that any of the one or more mobile machines has an insufficient amount of the consumable liquid available. This method reduces downtime of the mobile machines because liquid is supplied during the preferred periods while reducing the likelihood of running out of liquid.

### CROSS-REFERENCE TO RELATED APPLICATIONS

The present application claims priority from Australian Provisional Patent Application No 2013902465 filed on 3 Jul. 2013. the content of which is incorporated herein by reference.

### TECHNICAL FIELD

This disclosure relates to scheduling the supply a consumable liquid to a mobile machine, for example, but not limited to the supply of water to a blasthole drill.

### BACKGROUND ART

Blasthole drills are commonly used in mining operations to prepare the ground for subsequent blasting. These blasthole drills as well as other mobile machines consume liquids, such as fuel and water. Instead of moving the mobile machines to the main water supply it is more economical to deploy a supply vehicle to fill the mobile machines.

When the level of water or fuel in the mobile machine reaches a lower threshold, the operator sends a request for the supply of liquid. However, the timely supply of liquid cannot be guaranteed, for example, when multiple mobile machines request supply within a short time. As a result, the mobile machines could run out of water or fuel, which causes undesirable downtime associated with higher costs of the mining operation.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

A method for determining a supply schedule to supply a consumable liquid to one or more mobile machines in a mine comprises:
receiving from the one or more mobile machines status information relative to a machine cycle, the machine cycle comprising one or more first periods where supply of the consumable liquid is preferred; and
determining based on the status information the supply schedule to supply the liquid to the one or more machines during their respective one or more first periods such that the supply schedule reduces the likelihood that any of the one or more mobile machines has an insufficient amount of the consumable liquid available.

It is an advantage that determining the supply schedule is based on the status information. As a result, the supply schedule is determined such that the liquid is supplied during the preferred periods while reducing the likelihood of running out of liquid. This reduces downtime of the mobile machines since supply is scheduled such that the mobile machine is not interrupted in its work. Therefore, efficiency and productivity is increased.

The machine cycle may comprise one or more second periods where supply of the consumable liquid is undesirable.

The one or more machines may be one or more blasthole drills and then the one or mom first periods may comprise a drilling period and the one or more second periods may comprise two levelling periods and a tramming period.

The method may further comprise determining predicted status information based on the received status information, wherein determining the supply schedule is based on the predicted status information.

Determining the supply schedule may comprise determining supply times at which to supply the one or more mobile machines with the liquid.

The method may further comprise receiving a measurement of a current amount of liquid from one or more mobile machines, wherein determining the supply schedule is based on the measurement of the current amount of liquid.

The liquid may be water.

The method may further comprise receiving location information associated with the one or more mobile machines, wherein determining the supply schedule is based on the location information associated with the one or more mobile machines.

Determining the supply schedule comprises determining a sequence in which to supply two or more of the mobile machines with the liquid.

The method natty further comprise receiving location information associated with the one or more mobile machines, wherein determining the sequence comprises determining the sequence based on the location information such that a cost for travelling between the mobile machines in the sequence, is minimised.

The cost may be based on one or more of
distance,
fuel consumption,
road usage, and
travel time.

The cost may be based on whether mobile machines that are immediately consecutive to one another in the sequence are located on the same bench of an open pit mine.

The method may further comprise receiving work schedule information of work scheduled to be performed by the one or more mobile machines, wherein determining the supply schedule is based on the work schedule information.

The method may further comprise receiving location information associated with one or more supply machines, wherein determining the supply schedule is based on the location information associated with the one or more supply machines.

Determining the supply schedule may comprise determining the supply schedule to supply the liquid multiple times to the one or more mobile machines.

A non-transitory computer readable medium has an executable program stored thereon that when executed causes a computer to perform the method.

A computer system for determining a supply schedule to supply a consumable liquid to one or more mobile machines in a mine comprises:
an input port to receive from the One or more mobile machines status information relative to a machine cycle, the machine cycle including one or more first periods where supply of the consumable liquid is preferred; and
a processor to determine based on the status information the supply schedule to supply the liquid to the one or more machines during their respective one or more first periods such that the supply schedule reduces the likelihood that any of the one or more mobile machines has an insufficient amount of the consumable liquid available.

A method for mine automation comprises:
receiving data related a current amount of liquid from multiple mobile machines;
receiving work schedule information of work scheduled to be performed by the multiple mobile machines;
determining a supply schedule based on the received data and work schedule information such that the supply schedule reduces the likelihood that any of the one or more mobile machines has an insufficient amount of the consumable liquid available; and
directing one or more automated supply machines to the multiple mobile machines based on the supply schedule.

A non-transitory computer readable medium has an executable program stored thereon that when executed causes a computer to perform the method of claim 16.

A computer system for mine automation comprises:
an input port to receive data related a current amount of liquid from multiple mobile machines and to receive work schedule information of work scheduled to he performed by the multiple mobile machines;
a processor to determine a supply schedule based on the received data and work schedule information such that the supply schedule reduces the likelihood that any of the one or more mobile machines has an insufficient amount of the consumable liquid available; and
an output port to direct one or more automated supply machines to the multiple mobile machines based on the supply schedule.

Optional features described of any aspect of method, computer readable medium or computer system. Where appropriate, similarly apply to the other aspects also described here.

### BRIEF DESCRIPTION OF DRAWINGS

An example will be described with reference to

FIG. 1 illustrates a simplified open-pit mine.

FIG. 2 illustrates a computer system for determining a supply schedule to supply water to drills.

FIG. 3 illustrates a method for determining a supply schedule to supply water to drills.

FIG. 4 illustrates a management interface of a mine.

FIG. 5 illustrates a scheme for heuristically determining a supply schedule.

FIG. 6 illustrates a method for mine automation.

### BEST MODE FOR CARRYING OUT THE INVENTION

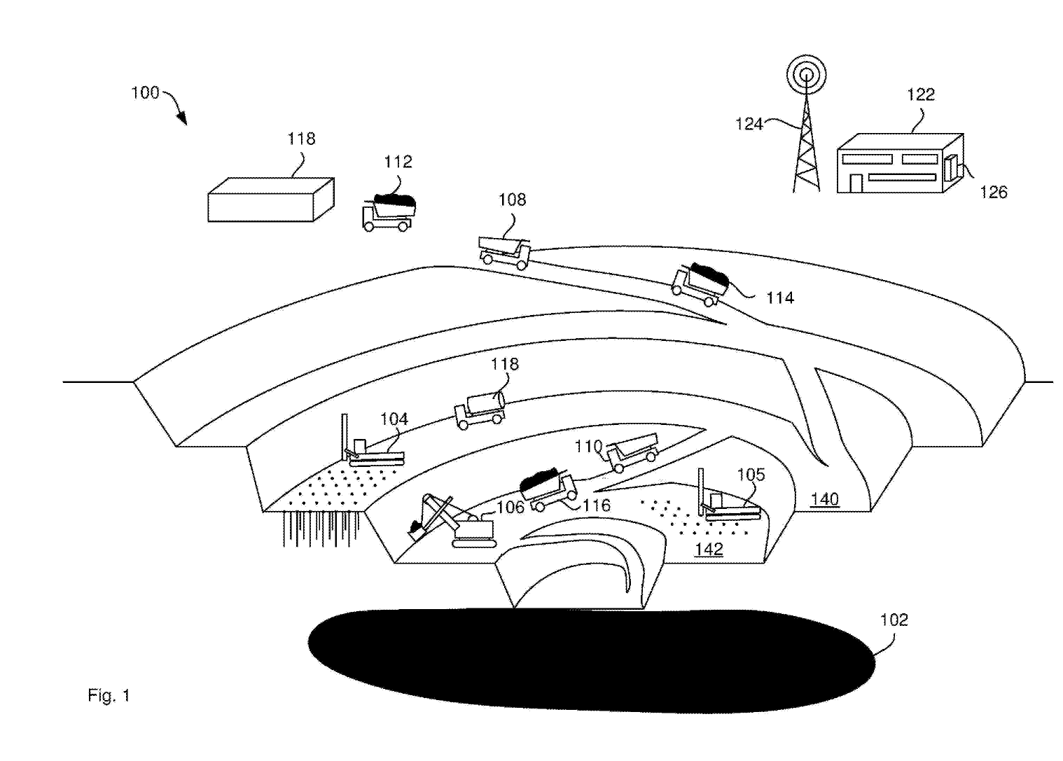

FIG. 1 illustrates a simplified open-pit mine 100. Although FIG. 1 shows an open-pit operation, it is to be understood that the invention is equally applicable to underground operations. The mine 100 comprises an iron ore deposit 102, two blasthole drills 104 and 105, a shovel 106, empty trucks 108 and 110 and loaded trucks 112, 114 and 116. The mine 100 further comprises a supply machine 118, such as a water filler. The drill 104 drills blastholes, the material is blasted and then loaded onto truck 110. The truck 110 then transports the material to a processing plant 118. Similarly, drill 105 also drills blastholes for later blasting.

The drills 104 and 105 consume water for lubrication, cooling and removal of drill cuttings from the hole. Drills 104 and 105 each comprise a tank to hold the water and the water filler 118 supplies fresh water to drills 104 and 105. If any of the drills 104 and 105 runs out of water, the mining operation is stalled. While the resulting delay is not catastrophic, it has a significant economic impact and results in an extra cost. Therefore, the likelihood of any of the drills 104 and 105 running out of water needs to be reduced. It is noted here that the term ‘likelihood’ is not to be understood in a strict mathematical sense but as a synonym for ‘probability’, ‘possibility’, ‘chance’ and the like.

While some of the following examples relate to the mining of iron ore, it is to be understood that the invention is also applicable to other mining operations, such as extraction of coal, copper or gold. It is further to be understood that the proposed controls are applicable for any number of drills and water fillers.

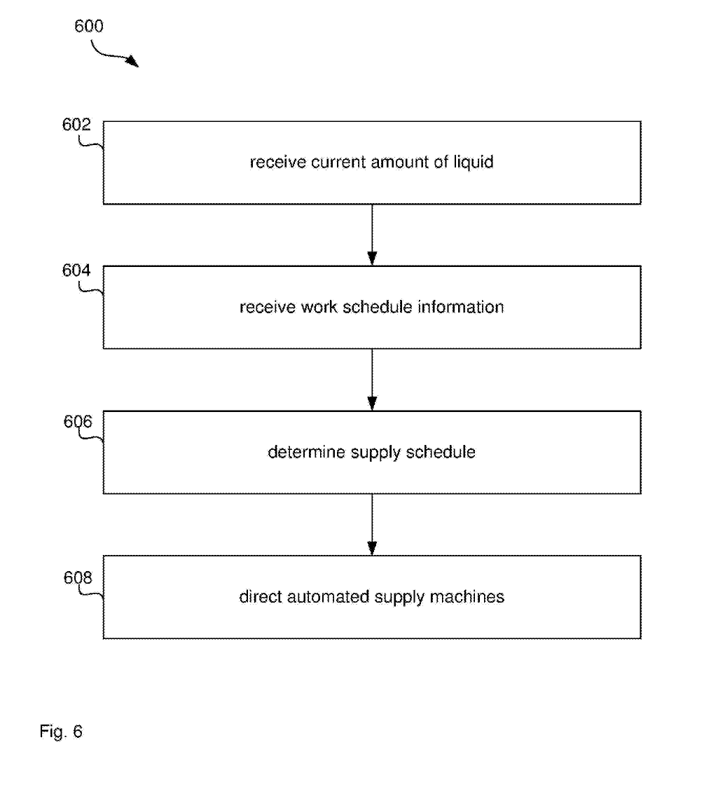

The mine further comprises a control centre 122 connected to an antenna 124 and hosting on it computer 126 it mine automation system. The mine automation system monitors operation and status data received from the mining machines wirelessly via antenna 124. The mine automation system further determines a supply schedule to direct the supply vehicle 118 to the drills 104 and 105 as will be explained with reference to FIG. 6. In one example, the control centre 122 is located in proximity to the mine site while in other examples, the control centre 122 is remote from the mine site, such as in the closest major city or in the headquarters of the resource company.

In this example, the mine layout comprises several benches, such as bench 140 on which blasthole drill 104 is located and bench 142, which is below bench 140 and on which blasthole drill 105 and excavator 106 are located.

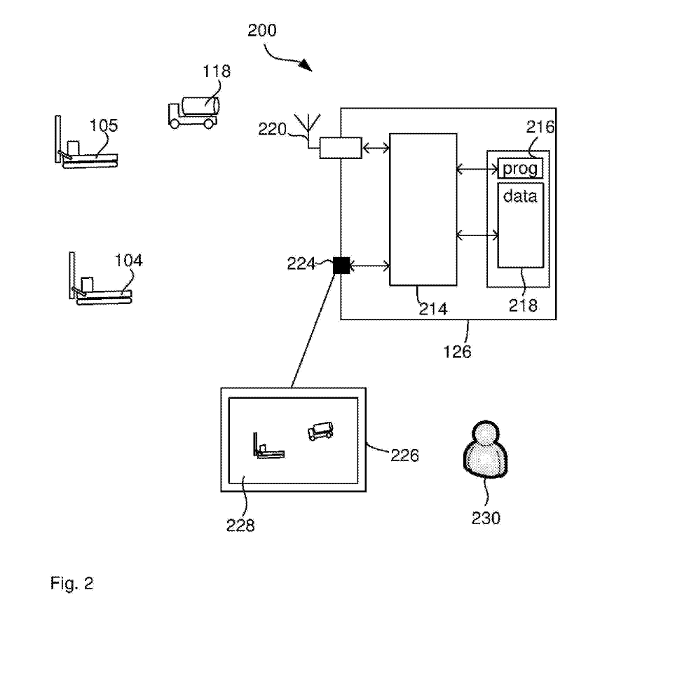

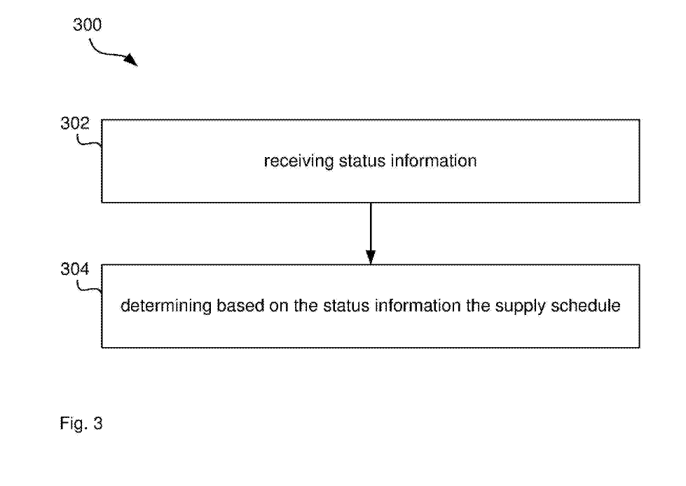

FIG. 2 illustrates a computer system 200 for determining a supply schedule to supply water to drills 104 and 105 in the mine 100. The computer system comprises computer 116 located in control centre 122 in FIG. 1. The computer 126 includes a processor 214 connected to a program memory 216, a data memory 218, a communication port 220 and a user port 224. The program tummy 216 is a non-transitory computer readable medium, such as a hard drive, a solid state disk or CD-ROM. Software, that is an executable program, stored on program memory 216 causes the processor 214 to perform the method in FIG. 3, that is, the processor receives status information and determines a supply schedule based on the status information.

The processor 214 may receive data, such as the status information, from data memory 218 as well as from the communications port 220 and the user port 224, which is connected to a display 226 that shows a visual representation 228 of the mine operations to an operator 220. In one example, the processor 214 receives status data from the drills 104 and 105 and data from the water filler 118 via communications port 220, such as by using a Wi-Fi network according to IEEE 802.11. The Wi-Fi network. may be a decentralised ad-hoc network, such that no dedicated management infrastructure, such as a router, is required or a centralised network with a router or access point managing the network.

In one example, the processor 214 receives and processes the status information in real time This means that the processor 214 determines the supply schedule every time status information is received from the drills 104 and 105 and completes this calculation before the drills 104 and 105 send the next status update.

Although communications port 220 and user port 224 are shown as distinct entities, it is to be understood that any kind of data port may be used to receive data, such as a network connection, a memory interface, a pin of the chip package of processor 214, or logical ports, such as IP sockets or parameters of functions stored on program memory 216 and executed by processor 214. These parameters may be handled by-value or by-reference in the source code. The processor 214 may receive data through all these interfaces, which includes memory access of volatile memory, such as cache or RAM, or non-volatile memory, such as an optical disk drive, hard disk drive, storage server or cloud storage. The computer system 200 may further be implemented within a cloud computing environment, such as a managed group of interconnected servers hosting a dynamic number of virtual machines.

Although the computer 126 is shown to be located in the control centre 122, it is to be understood that the computer 126 may equally be located elsewhere. In one example, the computer 126 is integrated into blasthole drill 104 and controls one or more water fillers without any influence from the control centre 122. In this way, the drill 104 is the master controller in an island of automation while the water fillers are saves of the drill 104. One advantage of such an arrangement is that the amount of data transferred to the control centre 122 is reduced, which is significant where the distance between the mine 100 and the control centre 122 is great and the data rate of communication is limited.

FIG. 3 illustrates a method 300 as performed by processor 214 for determining a supply schedule to supply water to drills 104 and 105 in a mine 100 of FIG. 1. A supply schedule can have various different forms. In one example, the supply schedule is a sequence in which to supply the drills with water. This sequence may be stored as a list of drill identifiers and the supply vehicle 118 moves to the drill identified by the topmost entry, fills that drill and moves to the second entry and so forth. In another example, the supply schedule provides detailed timing and location information of future actions of the supply vehicle, which may also be in form of a sequence.

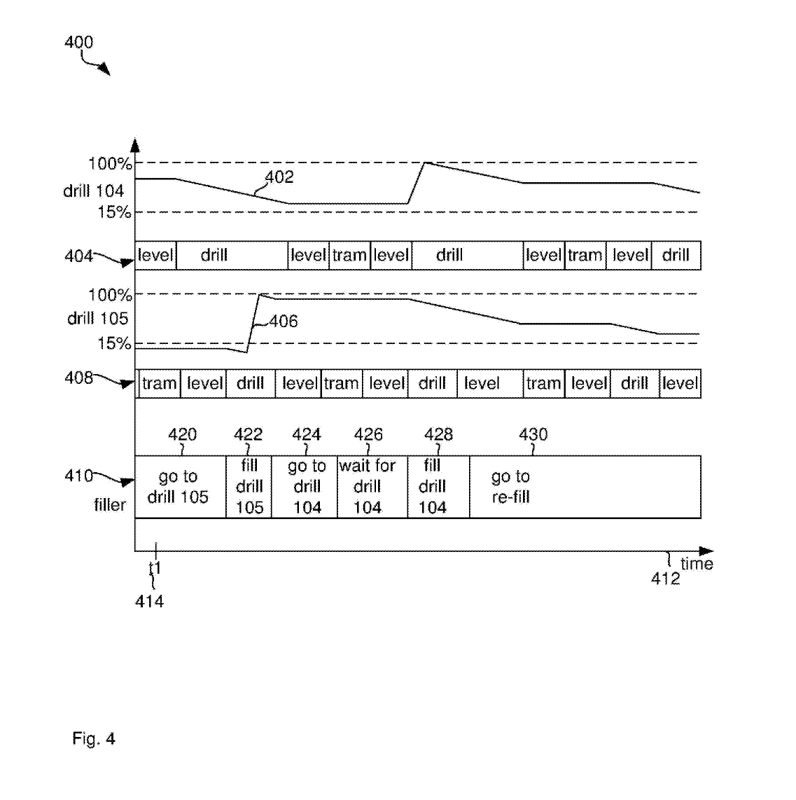

FIG. 4 illustrates a management interface 400 of mine 100. The management interface 400 may be displayed on display 226 of the control system 200 and comprises a first water level chart 402 and a first drill status indicator 404 for drill 104. The interface 400 further comprises a second water level chart 406 and a second drill status indicator 408 for drill 105. Finally, the interface 400 comprises a supply schedule 410 that is executed by supply vehicle 118. Management interface 400 displays data over time along time axis 412.

In this example, the drills have a machine cycle that comprises four phases. First, the drill trams to the desired hole location, then the drill levels the drilling platform by extending jacks onto the ground. Once the drill is levelled the drill starts the actual drilling and then the drill finally retracts the jacks again, which is also referred to levelling since it also comprises vertical movement of the drilling platform.

While the drill is in one of the levelling phase or the tramming phase, the drill moves. As a result, supplying liquid to the drill carries the risk of damaging the supply equipment. Therefore, the drill interrupts the drilling cycle by stopping the levelling or tramming movement to allow supply of water. Since this interruption causes the entire mining operation to be delayed, it is undesirable to schedule supply of the liquid to the drill during the tramming and the levelling phases.

Instead, it is preferred to supply water to the drill during the drilling phase where the drill is stationary and the production of the mine does not need to be interrupted. It is noted here that the teens ‘preferred’ and ‘undesirable’ are not meant in an absolute sense. As explained later, multiple factors may contribute to an overall cost of the supply schedule. While interrupting a drill during tramming may attract a high cost, the overall cost of the supply schedule may still be minimal considering all other contributions. For example, it may be optimal to interrupt a drill while the supply vehicle 118 closely passes by the drill when the alternative would be that the drill runs out of water and needs to wait for a long time before the supply vehicle 118 comes to that drill the next time.

The method of FIG. 3 commences by the processor 214 receiving from the drills 104 and 105 status information that is relative to the machine cycle as described above. The example of FIG. 4 starts at time t1 414. At this time, the processor 104 receives status information from drill 104 that drill 104 is in a levelling phase with 80% water level and status information from drill 105 that drill 105 is in a tramming phase with 10% water level. In this example, processor 214 follows a greedy algorithm and selects the drill with the lowest water level, that is, drill 105. The processor 104 then determines based on the machine cycle and the water level the supply schedule by scheduling the supply of drill 105 first and scheduling the supply of drill 104 second. Selecting the most critical drill reduces the likelihood that any of the drills 104 and 105 has an insufficient amount of water available.

In the example of FIG. 4, processor 214 determines schedule 410 such that supply vehicle 118 first moves 420 to drill 105. When processor 214 receives the status information of drill 105 at time t1 414, drill 105 is in the tramming phase. By the time the supply vehicle 118 arrives at drill 105, the drill has finished the tramming phase and the levelling phase and has started drilling. This means that the supply vehicle 118 can now supply water to drill 105. The water level 406 shows a steep rise at that time indicating the increase of water level caused by the refilling 422.

Meanwhile, the other drill 104 finished its levelling phase and started drilling. In one example, drill 104 sends status information each time the drill 104 changes to a different phase in the drilling cycle. In other examples, drill 104 sends status information periodically or the processor 214 polls status information periodically or on demand. It can be seen from the water level 402 of drill 104 how the water level slowly falls while the drill 104 is in the drilling phase.

The processor 214 receives the information that drill 104 is in the drilling phase and it is therefore preferred to supply water to drill 104. However, by the time the supply vehicle 118 finishes supplying 422 drill 105 and moves 424 to drill 104, drill 104 is already in a tramming phase and it is undesirable to supply water to drill 104. Therefore, supply vehicle 118 waits 426 for drill 104 to finish the levelling, tramming and levelling phases and supplies 428 water to drill 104 after that. Again, the supply to drill 104 can be observed by the rise in water level 402 before the water level 402 slowly falls again caused by the normal drilling operation. The supply vehicle 118 then returns to the main water supply to be refilled itself.

It is noted that various different approaches may be used to determine the supply schedule based on the status information and one potential approach will now be explained. This approach is based on a cost function that includes a number of current parameters as well as predicted parameters.

The prediction is performed by a predictor module executed by processor 214. The predictor module evaluates a model to predict the outcomes of certain operations. For example, the predictor module receives work schedule information of the drills 104 and 105, such as from data memory 218. The work schedule information includes future work that is to be performed by the drills 104 and 105 and may include a sequence of locations for drill holes to be drilled, a depth of each drill hole and an estimated drilling time to drill each drill hole. This estimated drilling time depends on the penetration rate and therefore on the property of the material, such as hardness.

Based on the received work schedule information, the predictor module predicts the duration of the tramming phases, that is the time it takes the drill to move to the next drill hole, and the duration of the dulling phases. For example, if the supply schedule determined by processor 214 includes as a first step supplying water to drill 105, the predictor module predicts the location and water level of the other drill 104 for the time in the future when the filling of drill 105 is completed.

Based on the predictions a cost function may be formulated. In one example, the cost function comprises terms for water level w (0 to 100) and the travel time t. Since a lower water level results in a lower cost, minimising the overall cost will prefer drills with lower water levels over drills with higher water level. The cost function will be explained in more detail later. The water level may be the predicted water level when the supply vehicle 118 arrives at the drill, that is after travel time t.

The travel time includes the time required to cross the distance to the next drill t_{d} and a potential waiting time t if the supply vehicle 118 arrives at the drill before the drill enters the drilling, phase and needs to wait for the drill to stop movement. This waiting time is based on the status information from the drill, that is in which phase of the cycle the dill currently operates. As a result, the waiting time and the cost function are also based on the status information. In order to determine the travel time, the processor 214 receives location information associated with each of the drills 104 and 105 and the supply vehicle. 118.

This location information may be a GPS coordinate, an identifier of a current bench or current blasting pattern or a spatial location represented in a coordinate system such as a mine coordinate system. The travel time is based on the location information and in turn, determining the supply schedule is based on the travel time. As a result, determining the supply schedule is based on the received location information.

By determining a supply sequence with minimal cost, the processor also minimises the cost for travelling between the mobile machines. It is noted here that ‘minimising’ does not necessarily mean to arrive at the absolute global minimum or the smallest value that is theoretically possible. This term may also mean arriving at a relative local minimum. In particular, the cost function may comprises the travel cost and the water level. Therefore, minimising this combined cost may achieve a smaller travel cost instead of the smallest possible travel cost but the travel cost is still said to be minimised.

Besides the travel time other parameters may also be taken to contribute to the travelling cost, such as the distance between the supply vehicle 118 and the drill or the expected fuel consumption for travelling the distance. In some examples, roads within the mine may be overloaded and the use of those roads may be penalised to avoid congestion caused by unnecessary movement of the supply vehicle 118.

The cost associated with as low water level may be modified such that solutions where drills run out of water are heavily penalised, such as using −1/w instead of w. The terms of the cost function are weighted by coefficients a resulting in the following mathematical expression for cost c:

c=a_{w}(w)+a₁(t_{d}+t_{w})

By choosing a large value for a_{w} the risk for one drill running out of water is prioritised over minimising the travel time of the supply vehicle 118.

The cost for supplying water to a specific drill i at a specific position in the supply sequence k is denoted as cᵢ^{k}.

In one example, the supply vehicle 118 supplies tour drills with water and the determination of the supply schedule starts at k=1. The processor 214 receives the current location of the supply vehicle 118 and the current location and status of the drills and determines the cost to supply water to each of the drills at k=1, that is the cost for each drill being the first drill to be supplied with water. This results in four cost values c₁¹, c₂¹, c₃¹ and c₄¹. In one example, the processor 214 selects the dull with the lowest cost and determines a supply schedule that comprises only a single drill. Once the supply vehicle 118 has completed the supply of that drill, the processor 214 repeats the same method to determine the next drill to be supplied with water. While the likelihood of any drill running out of water is reduced, this example does not take into account the prediction from the predictor module and may result in sub-optimal supply schedules.

In another example, the processor 214 considers future costs for supplying further drills given that a particular drill is chosen to be supplied first. Since the operation of a mine is, practically indefinite in time not all costs of future supply can be determined. Further, costs that are too far in the future are unreliable since they are subject to unpredictable variations. Therefore, processor 214 determines a sequence of drills d₁ of a given length, such as a sequence of four drills and these four drills are supplied with water in the given sequence, for example {d₃, d₁, d₄, d₁} while k (k=1, 2, 3, 4) is the incremental index of the sequence.

The processor 214 determines a cost function for a sequence of drills according to the following method. The processor 214 first determines the cost c₃¹ for supplying the first drill in the sequence as describe above. The processor then predicts the status and location of the drills at the time when the supply vehicle 118 completes the supply to the first drill Based on this predicted status information, the processor 214 determines the cost c₁² for supplying drill number 1 as the second drill. This process is repented for the other drills and the total cost for this exemplary supply schedule is c=c₃¹+c₁²+c₄³+c₁⁴.

An optimal solution can be found by generating every possible combination of supply schedules with repetitions of a given length, determining the cost for each supply schedule and selecting the supply schedule with the lowest cost. However, for longer supply schedules or more drills the number of possible combinations becomes intractable.

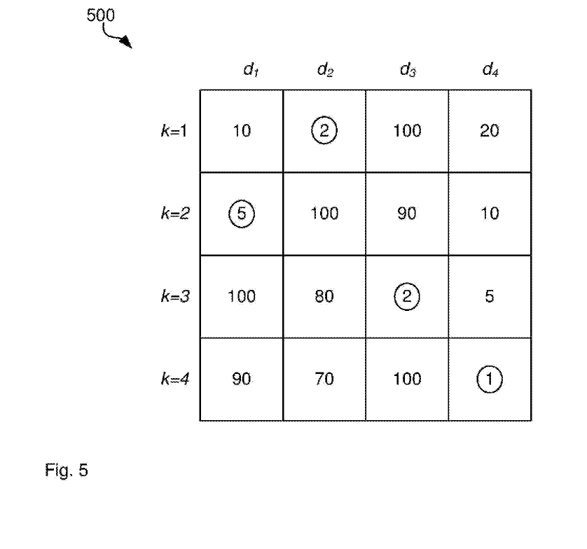

FIG. 5 illustrates a scheme 500 for heuristically determining a supply schedule. The processor 214 first determines the cost for k=1 as describe earlier. In this example, the water level of drill d₂ is low and the drill is also relatively close to supply vehicle 118, The cost for drill d₂ is 2. In contrast, the water level of drill d₃ is high and d₃ is relatively far away from supply vehicle 118. The cost for drill d₃ is 100. Therefore, the cost of drill d₂ is the smallest cost of all drills and drill d₂ is selected as the first drill to be supplied with water as indicated by the circle in the first row of FIG. 5. Next, the processor 214 predicts the future status information when supply to d₂ is completed and determines the cost for supplying each drill at k=2. Meanwhile, drill d₁ has used more water and therefore has a lower cost than at k=1. Drill d₁ is also the drill with the lowest cost and is therefore selected as the second drill in the supply sequence. This method is repeated until the required number of drills are selected for the sequence. In the example of FIG. 5 four drills are selected.

It is noted that this determination of the supply sequence is performed before the supply vehicle 118 actually starts moving to the first drill. Once the supply schedule is determined, the supply vehicle 118 may execute the supply schedule and the processor determines a new supply schedule once the supply vehicle 118 has supplied the last drill with water. Alternatively, the supply schedule may be re-computed based On updated status information every time the supply vehicle 118 completes the supply to a single drill. In that case, there are always four drills in the supply schedule.

In one example, the cost function comprises a penalty if the supply vehicle 118 needs to move to a different bench of the mine. As a result, selecting drills on the same bench may minimise the overall cost even if these drills have a high water level. Selecting drills on the same bench means that drills that are immediately consecutive in the supply sequence are located on the same bench. The processor 214 determines whether immediately consecutive drills are located, on the same bench. If they are not on the same bench, the processor 214 adds a penalty value to the cost function to favour supply schedules with minimal travel between benches.

When drills on the same bench are supplied together once, it is likely that future demand will be similar for those drills. As a result, the next time when one of these drills has a low water level, the other drills on the same bench will likely also have a low water level. The drills on one bench are synchronised and the overall travelling time of the supply vehicle 118 is reduced, which means that the same supply vehicle 118 in supply a larger number of drills. Such a staggered refilling sequence on the drills, reduces the likelihood that any one drill will run out of water due the water filler not getting there in time.

As described earlier, the predictor module predicts the time when the supply vehicle 118 completes the supply to a particular drill. In cases where the supply vehicle 118 arrives at the drill shortly before the drill completes the drilling phase, the remaining rime of the drilling phase may not be long enough to completely fill the tank of the drill. In that case, the interruption of the supply is considered as completing the supply of that drill and for the next k-value, the same drill may still have a low cost because of the small distance to the supply vehicle 118 and the low water level due to the previous supply being interrupted. As a result, the same drill may be chosen again and supply completed during the next drilling phase.

Depending on the number of drills and the length of the supply sequence, it may be common that each drill is selected multiple times for the supply sequence. The supply sequence may naturally develop a periodicity such that the sequence stays constant over a period of time, such as one week. If periodicity is detected the supply schedule does not need to be re-computed anymore but the status information needs to be monitored to detect any changes that could lead to a change in supply schedule.

FIG. 6 illustrates a method 600 for mine automation as performed by a computer system for mine automation under the control of software installed on a non-transitory medium, such as a hard disk drive, on the mine automation system. The mine automation system may comprise the same components as the system 200 in FIG. 2. The computer system receives 602 via an input port data related a current amount of liquid from multiple mobile machines. As described with reference to FIG. 2, the data may be received in various ways, such as from a data memory or from a network interface via the Internet. In one example, the mine automation system is located remotely from the mine itself and the data is transferred from the mine to the mine automation system via the Internet or a dedicated high speed data connection, such as fibre-optical cable.

In a similar way, the mine automation system receives 604 work schedule information of work scheduled to be performed by the multiple mobile machines. As also described earlier, the work schedule information contains locations of the mobile machines associated with future times. The work schedule information defines where the mobile machines are located at any time in the future.

The mine automation system further comprises a processor that determines 606 a supply schedule based on the received data and work schedule information such that the supply schedule reduces the likelihood that any of the one or more mobile machines has an insufficient amount of the consumable liquid available. The method described with reference to FIG. 5 may also be used here.

The mine automation system also comprises an output port to direct 608 one or more automated supply machines, such as autonomous water filler 118, to the multiple mobile machines based on the supply schedule. The output port may be the same as the input port, such as a bidirectional network connection. The processor of the mine automation system may direct the one or more automated supply machines by sending a supply schedule to each of the one or more supply machines, such as by sending a sequence of drills each supply machine.

The supply machine 118 is automated, which means that the supply machine 118 automatically makes decisions which are to a certain extend autonomous. For example. the supply machine 118 may have an on-board routing engine that determines the optimal travelling mute for the supply machine 118 to travel from drill 104 to drill 105. The supply machine 118 may further be autonomous in driving functions such as steering, accelerating, breaking and collision avoidance. In one example, an operator in the supply machine 118 monitors the operation and only takes over control in exceptional circumstances. Status information, such as speed and location may be transmitted to the mine automation system to monitor the operation of the supply machine.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include Volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating” or “generating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A method for determining a supply schedule to supply a consumable liquid to one or more mobile machines in a mine, the method comprising:
receiving from the one or more mobile machines status information relative to a machine cycle, the machine cycle comprising one or more first periods where supply of the consumable liquid is preferred; and
determining based on the status information the supply schedule to supply the liquid to the one or more machines during their respective one or more first periods such that the supply schedule reduces the likelihood that any of the one or more mobile machines has an insufficient amount of the consumable liquid available.

2. The method of claim 1, wherein the machine cycle comprises one or more second periods where supply of the consumable liquid is undesirable.

3. The method of claim 1, wherein the one or more machines are one or more blasthole drills.

4. The method of claim 3, wherein the one or more first periods comprise a drilling period and the one or more second periods comprise two levelling periods and a tramming period.

5. The method of claim 1, further comprising determining predicted status information based on the received status information, wherein determining the supply schedule is based on the predicted status information.

6. The method or claim 1, further comprising receiving a measurement of a current amount of liquid from one or more mobile machines, wherein determining the supply schedule is based on the measurement of the current amount of liquid.

7. The method of claim 1, further comprising receiving location information associated with the one or more mobile machines, wherein determining the supply schedule is based on the location: information associated with the one or more mobile machines.

8. The method claim 1, wherein determining the supply schedule comprises determining a sequence in which to supply two or more of the mobile machines with the liquid.

9. The method of claim 8, further comprising receiving location information associated with the one or more mobile machines, wherein determining the sequence comprises determining the sequence based on the location information such that a cost for travelling between the mobile machines in the sequence is minimised.

10. The method of claim 9, wherein the cost is based on one or more of
distance,
fuel consumption,
road usage, and
travel time.

11. The method of claim 9, wherein the cost is based on whether mobile machines that are immediately consecutive to one another in the sequence are located on the same bench of an open pit mine.

12. The method claim 1, further comprising receiving work schedule, information of work scheduled to be performed by the one or more mobile machines, wherein determining the supply schedule is based on the work schedule information.

13. The method of claim 1, further comprising receiving location information associated with one or more supply machines, wherein determining the supply schedule is based on the location information associated with the one or more supply machines.

14. The method of claim 1, wherein determining the supply schedule comprises determining the supply schedule to supply the liquid multiple times to the one or more mobile machines.

15. A non-transitory computer readable medium with an executable program stored thereon that when executed causes a computer to perform, the method of claim 1.

16. A computer system for determining a supply schedule to supply a consumable liquid to one or more mobile machines in a mine, the computer system comprising:
an input port to receive from the one or more mobile machines status information relative to a machine cycle, the machine cycle including one or more first periods where supply of the consumable liquid is preferred; and
a processor to determine based on the status information the supply schedule to supply the liquid to the one or more machines during their respective one or more first periods such that the supply schedule reduces the likelihood that any of the one or more mobile machines has an insufficient amount of the consumable liquid available.

17-19. (canceled)
